(19) United States
(12) Patent Application Publication
(10) Pub. No.: US 2010/0196701 A1
(43) Pub. Date: Aug. 5, 2010

(54) PAPER FOR OFFSET PRINTING

(75) Inventors: Gilbert Botty, Maastricht (NL); Philip Lemmens, Eijsden (NL); Jelena Fischer, Graz (AT); Sandra Hendrix, Maastricht (NL); Nicole Seidler, Gratwein (AT)

Correspondence Address: SUGHRUE MION, PLLC, 2100 PENNSYLVANIA AVENUE, N.W., SUITE 800, WASHINGTON, DC, 20037, US

(73) Assignee: SAPPI Netherlands Services B.V., Maastricht (NL)

(21) Appl. No.: 12/668,143

(22) PCT Filed: Jul. 5, 2008
(86) PCT No.: PCT/EP08/05504

§ 371 Date: Jan. 7, 2010

(30) Foreign Application Priority Data
Jul. 9, 2007 (EP) 07013375.6

(51) Int. Cl. B32B 5/16; B32B 17/06

(52) U.S. Cl. 428/331; 428/426; 428/323

(57) ABSTRACT

Disclosed is a printing sheet for offset printing, comprising at least one image receiving coating and optionally one or several pre-coatings beneath said image receiving coating, said coatings comprising a pigment part, a binder part, and optionally additives, wherein the pigment part essentially consists of one or a mixture of fine particulate pigments selected from the group of carbonate, kaolin, solid or vacuolated polymer pigment, wherein said binder part comprises waterglass.

### TECHNICAL FIELD

The present document pertains to a printing sheet for offset printing, comprising at least one image receiving coating and optionally one or several pre-coatings beneath said image receiving coating, said coatings comprising a pigment part, a binder part, and optionally additives, wherein the pigment part essentially comprises one or a mixture of fine particulate pigments selected from the group of carbonate, kaolin, clay, silica, gypsum and the like and/or solid or vacuolated polymer pigment.

### BACKGROUND OF THE INVENTION

Currently for the making of offset printing papers and generally graphic papers usually synthetic binders are used, mostly latex-binders or PVA-based binders and the like. These binders are made starting from non-renewable sources, typically crude oil or similar sources.

In addition to that, many of these binders show rather slow degradation increasing the environmental concerns associated with the use of these binders in the papermaking process. Correspondingly therefore more sustainable substitutes for the currently used binders are an ever increasing issue.

### SUMMARY OF THE INVENTION

One object of the present invention is therefore to provide an improved printing sheet for offset printing purposes which can be produced at reasonable costs, quickly and efficiently.

The present invention solves the above problem by using, for a printing sheet for offset printing or generally for graphic paper, comprising at least one image receiving coating and optionally one or several pre-coatings beneath said image receiving coating, said coatings comprising a pigment part, a binder part, and optionally additives, wherein the pigment part essentially comprises one or a mixture of fine particulate pigments preferably selected from the group of carbonate, kaolin, gypsum, clay, silica, solid or vacuolated polymer pigment, and wherein there is waterglass in the binder part.

The binder part which comprises waterglass is, according to the invention, present in at least one of the coating layers on a substrate. Correspondingly therefore, it is possible according to the invention that a standard middle coating or sizing layer (without waterglass in the binder) is combined with an image receiving layer with a binder part comprising waterglass. It is also according to the invention that a standard image receiving layer (without waterglass in the binder) is combined with a middle coating the binder part of which comprises waterglass. It is furthermore also according to the invention if the image receiving layer as well as a middle coating layer both have a binder part comprising waterglass.

Indeed it is in accordance with one of the preferred embodiments of the invention, that there is provided a printing sheet with an image receiving coating comprising a pigment part as defined above and a binder part, wherein the binder part is free of waterglass, and with a middle coating (or any intermediate coating between the actual paper substrate and the image receiving coating) comprising a pigment part as defined above and a binder part, wherein the binder part of the middle coating comprises waterglass.

It was unexpectedly found that in the context of offset printing paper coatings waterglass, i.e. the soluble silicate of the general formula (Na₂O).x(SiO₂) can be used as a constituent or even as the full binder part. It was first of all found that unexpectedly it is at all possible to coat in particular a carbonate pigment comprising coating formulation (or more generally coating formulations based on inorganic pigments which are usually applied with a pH of around 7-9, in particular coating formulations comprising calcium and/or magnesium and/or aluminium ions) comprising waterglass as a binder constituent, as the waterglass is highly sensitive for e.g. time delayed gelation at the low pH-values associated with the use of regular paper coating pigments, and on the other hand paper coatings/paper pigments cannot be processed if handled at too high a pH-value in practice. Additionally it was surprisingly found, that if waterglass is used as a binder, the gloss off the paper is, if at all, only insignificantly altered, while on the other hand printing properties are improved, e.g. the set off behaviour of the paper is improved. A further improvement of the use of waterglass can be seen in the ecological and economic advantages of the replacement of conventional (e.g. latex) binders. So to sum up, waterglass is a viable substitute for organic synthetic binders without any significant drawbacks, and under certain conditions even leads to improved paper properties compared with the use of organic synthetic binders such as latex.

The coating in accordance with the present invention can be used for various types of paper, so for calendered or uncalendered paper, for matt, silk or glossy types, and the coating can be applied on one or both sides of a paper substrate.

It is noted that in the context of this part of the description and of the claims the term part per dry weight is to be understood as follows: the pigment part makes up 100 parts per dry weight and may be constituted by individual fractions, e.g. a fine fraction and a coarse fraction, e.g. a calcium carbonate fraction and Kaoline and/or plastic pigment fraction etc. The additional components like binder and additives are given as part per dry weight calculated in relation to these 100 parts of the pigment part.

According to a first embodiment of the invention, the image receiving coating, so the top coating, and/or at least one of the pre-coatings, comprises a pigment part, a binder part, and optionally additives, wherein the pigment part essentially comprises one or a mixture of fine particulate pigments selected from the group of carbonate, kaolin, gypsum, clay, silica, solid or vacuolated polymer pigment and the like, and wherein said binder part in the image receiving coating and/or the pre-coating(s) comprises waterglass. In principle however also a second or third coating (precoatings) provided below the top coating can have such a formulation with a binder comprising waterglass. It is possible to have waterglass in the binder as described herein in a top coating as well as in a pre-coating.

Particularly good printing behaviour can be achieved if for a pigment part of 100 parts per dry weight the binder is present as 2-18 parts per dry weight, preferably 3-12 parts per dry weight, even more preferably 6-10 parts per dry weight. Under these conditions, optional additives may constitute another 0-5 parts per dry weight, preferably 0.1-2 parts per dry weight. The additives may comprise components acting as co-binders (e.g. starch, PVA), and if such additives are present these are preferably present in an amount of 0.1-2 parts per dry weight, preferably 0.5-1.5 parts per dry weight. Possible are e.g. those selected from the group PVA, CMC, modified starch etc. Possible examples are of the type of Mowiol or C*Film. According to a further embodiment of the invention, at least 10% of the dry weight of the binder part and preferably not more than 90% are constituted by waterglass. It is furthermore possible if at least 45%-80%, preferably 50%-70% of the dry weight of the binder is constituted by waterglass. It is however also possible to have a coating formulation in which essentially all of the binder part is constituted by waterglass.

The remainder of the binder part in these cases is constituted by another, non-waterglass binder, preferably selected from the group consisting of latex, in particular styrene-butadiene, styrene-butadiene-acrylonitrile, carboxylated styrene-butadiene, styrene-acrylic, styrene-butadiene-acrylic latexes, starch, polyacrylate salt, polyvinyl alcohol, soy, casein, carboxymethyl cellulose, hydroxymethyl cellulose and mixtures thereof.

According to a specifically preferred embodiment, the binder part of at least one of the coating layers, preferably of the middle coating layer (and most preferably only of the middle coating layer) comprises a conventional binder of the latex type, waterglass as well as a starch type binder. Typically the starch part of the binder part makes about 5-30%, preferably 10-15% of the total weight of the binder part. The waterglass part typically makes about 0.5-50%, preferably 15-30% of the total weight of the binder part. The rest of the total weight of the binder part complementing to 100% is typically given by the latex type binder. One possible binder part can for example be given by 6.5 parts per weight latex binder, 2 parts per weight waterglass and 1.5 parts per weight starch type binder, if the total binder part is 10 parts per weight.

If starch type binder is also present next to waterglass type binder in the binder part, it is preferred if the starch type binder is selected from the group of hydroxy-propylated starch or dextrine starch or combinations thereof When selecting these types of starch type binders a good compatibility with waterglass results and the rheology of the resulting coating formulations is stable over time, in case of selecting other types of starch binders it is possible that the coating turns completely solid in a very short time.

Indeed the constituents of the coating formulation, and in particular of the binder part, are generally selected such as to make sure that the Brookfield viscosity at 100 rpm and a temperature of 23° C. and a solids content of around 68% remains below 2000 mPa·s after six hours, preferably relating below 1800 mPa·s after six hours. This can be used as a testing scheme to find out which constituents apart from waterglass are suitable. Correspondingly therefore it is preferred that for example the latex type forming the latex binder part of the binder part is selected such that indeed in combination with waterglass these stability conditions for the viscosity are met. Preferably these values are still met after even 24 hours.

Indeed one notices that independent of the type of latex binder some products on the market are compatible with waterglass in the binder part and some are not. Those which are not compatible show a quick increase of viscosity over time or already initially the viscosity is high. Without being bound to this explanation, it seems that therefore not the type of the latex binder but rather the further constituents of the latex formulation commercially available are responsible for this behaviour. If however the above testing scheme is used one can easily find suitable latex type binders.

According to a further preferred embodiment of such a printing sheet, at least 50%, preferably at least 75% of the dry weight of the pigment part consists of a carbonate and/or kaolin pigment. It is completely unexpected that in this case, where the pigment comprises a high load of calcium (and/or aluminium and/or magnesium) ions, waterglass can actually be used as the binder at pH values below or at 11 or even below or at pH of 10.

According to a further preferred embodiment of such a printing sheet, the pigment part is composed of a) 50 to 100 parts in dry weight of a fine particulate carbonate with a particle size distribution such that more than 60%, preferably 80% of the particles are smaller than 2 μm (micrometre), preferably smaller than 1 μm (micrometre), preferably with a particle size distribution such that approximately 90% of the particles are smaller than 1 μm (micrometre). A second optional fraction of the pigment part may be given by b) 0 to 50 parts in dry weight of a fine particulate kaolin with a particle size distribution such that more than 90% of the particles are smaller than 2 μm (micrometre), preferably smaller than 1 μm (micrometre), preferably with a particle size distribution that more than 95% of the particles are smaller than 1 μm (micrometre). The third optional fraction of the pigment part may be given by c) 0 to 20 parts or up to 30 parts in dry weight of a particulate, preferably solid or vacuolated polymer pigment, in case of solid pigments with a particle size distribution such that more than 90% of the particles are smaller than 0.5 μm (micrometre), preferably with a particle size distribution such that 90% of the particles have sizes between 0.05 and 0.3 μm (micrometre), in particular between 0.1 and 0.2 μm (micrometre), and in case of vacuolated pigments with a mean particle size in the range 0.6-1 μm (micrometre). Also more of coarse pigments can be present in the pigment part, so for example d) 0-20 parts in dry weight (preferably 0.5-10 parts in dry weight) of another pigment, preferably of a particulate carbonate and/or kaoline with a particle size distribution such that more than 50% of the particles are smaller than 2 μm (micrometre), preferably with a particle size distribution such that approximately 60% of the particles are smaller than 2 μm (micrometre), the total of the pigment part making 100 parts in dry weight.

One specific formulation in particular for a top coating is given if pigment part is composed of 85 to 98 parts in dry weight of a particulate carbonate with a particle size distribution such that more than 80% of the particles are smaller than 1 μm, preferably with a particle size distribution such that approximately 90% of the particles are smaller than 1 μm, and of 2-15 parts in dry weight, preferably 0.5-10 parts in dry weight of a particulate carbonate with a particle size distribution such that more than 50% of the particles are smaller than 2 μm, preferably with a particle size distribution such that approximately 60% of the particles are smaller than 2 μm.

Typically in the above cases the additives can be selected from the group of defoamers, colorants, brighteners, dispersants, thickeners, water retention agents, preservatives, crosslinkers, lubricants and pH control agents and mixtures thereof.

Typically furthermore, the image receiving layer has a total dried coat weight of in the range of 3 to 25 g/m², preferably in the range of 4 to 15 g/m², and most preferably of about 6 to 12 g/m². The total paper grammage is typically given in the range of 80 to 400 g/m², preferably of 100 to 250 g/m² after the coating process.

It is noted that even if waterglass is used as a binder, a gloss on the calendered surface of the image receptive coating of more than 70% according to TAPPI 75 deg is possible.

In order to keep processing conditions even at high waterglass content in the binder fraction within practical boundaries (rheology etc) it is advisable to have a weight ratio R(w) of SiO₂:Na₂O in the waterglass above or equal to 3.2, preferably above or equal to 3.4. In particular for very high waterglass content or even full replacement of the binder by waterglass it is advisable to have a weight ratio above or equal to 3.6, preferably above or equal to 3.8. It was indeed found that if the ratio is around 1-2, this quality of the resulting coating formulation is either too high already initially or becomes too high to quickly. Correspondingly therefore it is preferred that the ratio is in the range of 3.2-3.9, most preferably in the range of 3.25-3.9.

It has been found that also the turbidity of the sodium silicate solutions used in the coating process can have a strong influence on the viscosity of the coating colours and therefore on the practicability of the coating process. With increasing turbidity of the sodium silicate solution, the viscosity of the coating mixture increases. Without being bound to such an explanation, it seems that this is due to the fact that the lower the turbidity, the less large particles are present in the waterglass solution. It was furthermore found that unexpectedly the more large particles of sodium silicate the higher the tendency of high viscosity or development of high viscosity in a resulting coating formulation of the time. Indeed, in such a case the viscosity of the mixtures increases more rapidly over time with the increasing turbidity of the sodium silicate solution. If however the turbidity of the waterglass solution used for the making of the coating formulation is low (1-4 nephelometric turbidity units, NTU), the viscosity of the coating mixtures is low and also the stability of the coating mixtures is better (increase in viscosity over time is not as rapid). The coating mixtures can therefore be optimized by choosing sodium silicate solutions as starting material with turbidity values between 1 and 3.5 NTU, preferably with turbidity values in the range of 2-3 NTU. Typically also a rheology modifier (such as CMC, synthetic types or the like) is used in the coating formulation. In comparison with a standard coating formulation if waterglass is used as a constituent of the binder part the rheology modifier content should be increased to twice as much or thrice as much as in the standard situation. This leads to a rheology modifier content in the range of 0.2-0.6 parts per weight. This for example under conditions in which waterglass makes about 10-50% of the binder part, a starch type binder makes up about 5-30%, and the rest of the binder part complementing to 100% is given by a conventional binder such as latex.

Preferably the rheology modifier (and generally any functionally active additives in the coating formulation) is selected such as to be active at a pH-value of in the range of 9-11.5, preferably of 10.5-11.5.

The waterglass can be supplemented with additives and/or can be chemically modified. This chemical modification or supplementation with additives can be used for altering the rheological properties of the coating and/or for altering/optimising the final paper/coating properties and the like. In particular these modifications of the chemical nature of the waterglass can be done on the backbone of the waterglass structure, and it can be used for preventing or at least slowing the gelation process which can take place under certain conditions. It should be noted that the supplementation with specific additives for the waterglass can either be done prior to the actual mixing/preparation of the coating formulation, so the waterglass can be fed into the coating formulation making process already in combination with the additive. In the alternative it is however also possible to add these additives only in the coating making process, so to e.g. add the additives concomitantly with the addition of the waterglass in the coating making process.

Furthermore the present invention relates to a method for making a printing sheet as given above. Preferably in this method during coating preparation and/or application the pH value of the coating formulation comprising waterglass is kept in the range of 10.5-11.5 or alternatively smaller or equal to 10, preferably smaller or equal to 9. If at least 50% of the binder part is constituted by waterglass dilution of the coating formulation to below 70%, preferably to at most 65% can be advantageously carried out prior to or concomitant with application of the coating.

If at least 75% of the binder part is constituted by waterglass dilution of the coating formulation to at most 65% can be carried out prior to application of the coating.

Furthermore the present document relates to the use of a printing sheet as given above or made as given above in an offset printing process.

Further embodiments of the present invention are outlined in the dependent claims.

### SHORT DESCRIPTION OF THE FIGURES

In the accompanying drawings preferred embodiments and documentary evidence of the invention are shown wherein:

FIG. 1 shows Rheolab viscosity measurements for Na-silicate, weight ratio R(w)=3.28;

FIG. 2 shows the set off of calendered papers with Na-silicate, weight ratio R(w)=3.28;

FIG. 3 shows Rheolab viscosity measurements for Na-silicate, weight ratio R(w)=3.9;

FIG. 4 shows gloss as function of Na-silicate content in formulation;

FIG. 5a) shows the set off of top coated papers and b) the set off after calendering;

FIG. 6a) shows the set off of top coated papers and b) the set off of calendered papers

### DETAILED DESCRIPTION OF THE PREFERRED EMBODIMENTS

With today's increasing crude oil prices, organic (latex) binders have become a major cost entry for coating formulations and end paper cost prices. Furthermore there are severe environmental concerns associated with the use of these synthetic organic binders.

Therefore possibilities to substitute latex for a less expensive and more sustainable alternative are looked for. Such alternative should of course perform equally well. In addition the new substance is preferably subject to sustainable development with the ever more strict regulations concerning environmentally friendly and safe production of materials.

One material unexpectedly efficiently fulfilling these demands and currently object of this document is soluble sodium silicate.

Soluble silicates are one of the oldest and most benign industrial chemicals. Sodium silicates are manufactured by fusing sand (SiO₂) with sodium carbonate (Na₂CO₃) at 1200° C. The resulting glass can be dissolved with high pressure steam to form a clear, slightly viscous liquid known as “waterglass”. These liquids can be spray-dried to form quick-dissolving hydrous powders. Dissolved or liquid silicates, however, are the most popular commercial form of application. In addition to sodium silicates also potassium variants exist. If in this document reference is made to waterglass this shall include soluble sodium and/or potassium silicates of the general formula (Na₂O).x(SiO₂) (or also (K₂O).x(SiO₂)).

The waterglass may comprise or be supplemented with stabilizers such as quaternary ammonium compounds e.g. to stabilize the rheological properties but also to influence the final paper properties like gloss, ink setting, etc. Such stabilizers are known from the field of paints with waterglass, and reference is made e.g. to a system as disclosed in EP-A-1431354.

Furthermore the waterglass can be chemically modified for the purposes of the use according to the present invention. Chemical modification can for example be effected by modifying the backbone of the waterglass, this in order to again amend the rheological properties relevant for the coating process, other properties critical in the production process of a paper/coating and/or four amending/optimising the final properties of the paper.

One resulting property from the silicate chemistry is the possibility to form a matrix or chemical bonds. This makes this material suitable for usage as inorganic binder for which it is used in several industries, e.g. for paints as discussed above. Typical applications are therefore:
Corrugated board adhesive
Foil-to-paper lamination
Binder for fibrous building products (e.g. ceiling insulation)
Ceramics or powdered metals for high temperature curing
Paint vehicle

One important characteristic of soluble silicates is the weight ratio SiO₂:Na₂O, which is given as R(w). Typically this ratio varies between 1.1 and 3.4 and is of importance for the physical properties of soluble silicates.

Another factor being influenced by the weight ratio is the pH of silicate solutions as such. Soluble silicates as such typically possess high pH values (10-13). An increasing weight ratio will decrease pH. It is important to realize that all sodium silicate solutions as such will polymerize in a gelation process to form a viscous if not solid silica gel when pH value is reduced below 10. In the pH range between 8-10 and also 2-5 so-called time-delayed gelation (unstable salts) can occur, depending not only on weight ratio but, amongst others, also on concentration and temperature. In the intermediate region of pH 5-8 this gelation phenomenon is very rapid.

Lastly, a typical difficulty for the present paper coating application is the reaction of soluble sodium silicates with dissolved polyvalent (free) cations such as Ca²⁺, Al³⁺ and Mg²⁺. The extent and rate of reaction depends on the nature of the salt and its physical and molecular structure. For example, mineral calcium carbonates, like calcite, exhibit limited interaction with soluble silicates, whereas PCC's generally show high reactivity.

In the following experimental section the use of sodium silicate as inorganic binder is reported. It is specifically pointed out that the examples given below serve to support and document the present invention. They shall not be construed to limit the extent of protection as defined in the claims which are attached to the specification.

Experiments 1: Results with Sodium silicate with R(w)=3.28

The following program was followed (see table 1).

TABLE 1
Program with Na-silicate product R(w) = 3.28

Trial-Nr.

| Product | SC | REF | PQ1 | PQ2 |
|---|---|---|---|---|
| Setacarb HG | 75.0 | 97.00 | 97.00 | 97.00 |
| Hydrocarb 60 | 78.0 | 3.00 | 3.00 | 3.00 |
| C*Film 5773 | 25.0 | 0.40 | 0.40 | 0.40 |
| Mowiol 4-98 | 22.0 | 1.80 | 1.80 | 1.80 |
| Eurolatex L 0607 | 50.0 | 8.00 | 7.00 | 6.00 |
| Na-Silicate, R(w) = 3.28 | 40.0 | | 1.00 | 2.00 |
| Sterecoll BL | 30.0 | 0.03 | | |
| Calciumstearaat RG 50/2 | 50.0 | 0.70 | 0.70 | 0.70 |

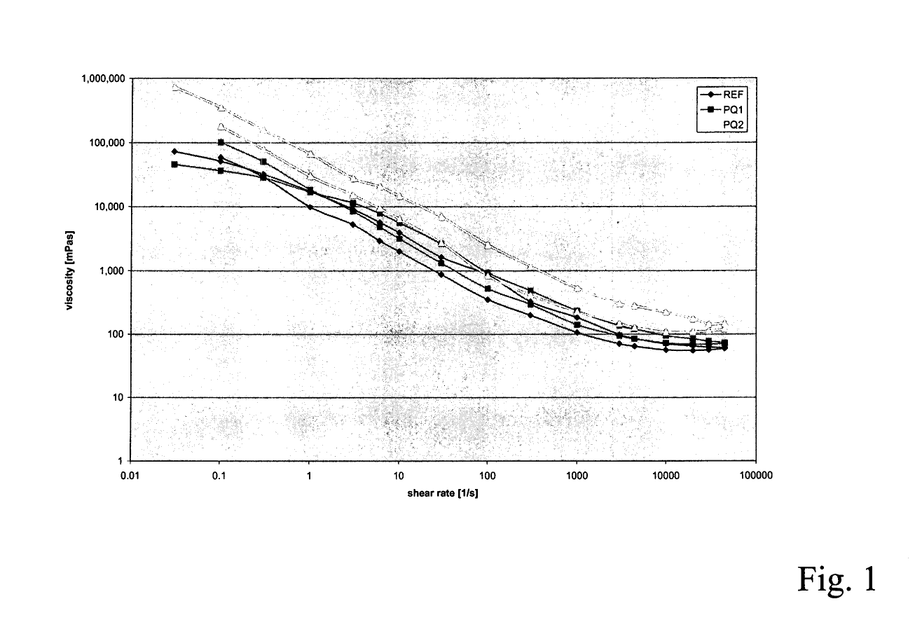

After preparation, the coatings were rheologically measured and the results are given in FIG. 1.

It is noticed here that the coatings with Na-silicate show increased viscosity with increasing Na-silicate content.

Two of these coatings, with 1 and 2 parts Na-silicate, were coated onto pre-coated paper. In further step, the two papers PQ1 and PQ2 were calendered, using a lab calender, presenting 2× steel nip to the paper surface (90° C., 50 bar). These data are given in table 2.

TABLE 2
Measurements on calendered papers with Na-silicate R(w) = 3.28

| | | | |
|---|---|---|---|
| Product/Trial-Nr. | REF | PQ1 | PQ2 |

| Spec. Volume | | | | | |
|---|---|---|---|---|---|
| Grammage | | g/m² | 226.0 | 226.0 | 226.5 |
| Caliper | | μm | 194.0 | 194.0 | 196.0 |
| Spec. Volume | | cm³/g | 0.86 | 0.86 | 0.87 |
| Coating amount | | g/m² | 12.0 | 12.0 | 12.5 |
| Moisture | | % | 5.3 | 5.2 | 5.3 |
| Gloss | | | 90° C.; 50 bar; 2 x steel | | |
| Gloss Tappi 75° | top | % | 74.7 | 71.1 | 70.5 |
| Gloss DIN 75° | top | % | 50.6 | 46.2 | 45.7 |
| Gloss DIN 45° | top | % | 15.4 | 12.1 | 11.5 |

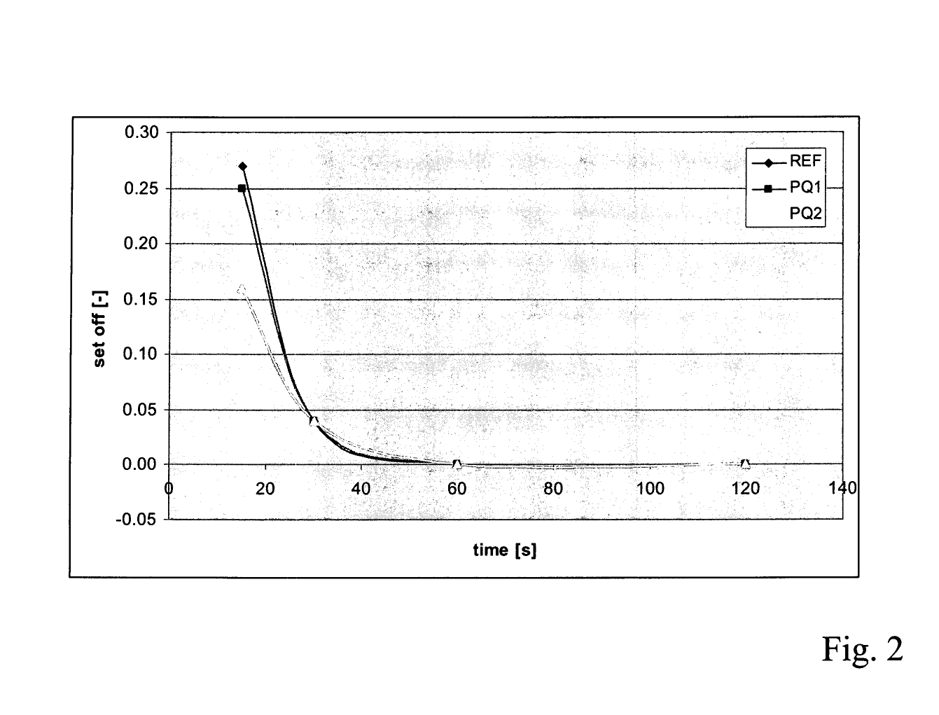

In this case a slight gloss decrease in Tappi 75°, DIN 75° and DIN 45° is observed with increasing Na-silicate. In a last step printing parameters were measured for these two papers after calendering. These results are given in FIG. 2 and table 2.

An advantage in ink setting can be observed in the Figure with 2 parts Na-silicate as inorganic binder substitute for latex. In table 3 below it is further seen that Micro Pick and Wet Pick tend to be slightly lower but still acceptable than reference paper.

TABLE 3
Pick values of calendered papers with Na-silicate R(w) = 3.28

| Product/Trial-Nr. | | | REF | PQ1 | PQ2 |
|---|---|---|---|---|---|
| MCMP | | | | | |
| Huber 48002 | top | x free | 3 | 2 | 2 |
| Wet Pick | | | | | |
| Huber 48002 | top | x free | 3 | 2 | 2 |

Experiments 2: Results with Sodium silicate with R(w)=3.9

It was noticed that possibly (partial) gelation of Na-silicate can take place after it has been mixed into the coating colour. This can perhaps be due to a pH shock or the presence of Ca²⁺ ions in the solution. In view of this another product, with higher weight ratio, was used for testing. A higher weight ratio can improve Ca²⁺ stability and pH should be slightly lower (note: but still above 10).

For this series, a similar set up like for the above experiments was chosen (see table 6).

TABLE 4
program with Na-silicate product R(w) = 3.9

| Product/Trial-Nr. | SC | REF | PQ10 | PQ11 | PQ12 | PQ13 |
|---|---|---|---|---|---|---|
| Setacarb HG | 75.0 | 97.00 | 97.00 | 97.00 | 97.00 | 97.00 |
| Hydrocarb 60 | 78.0 | 3.00 | 3.00 | 3.00 | 3.00 | 3.00 |
| C*Film 5773 | 25.0 | 0.40 | 0.40 | 0.40 | 0.40 | 0.40 |
| Mowiol 4-98 | 22.0 | 1.80 | 1.80 | 1.80 | 1.80 | 1.80 |
| Eurolatex L 0607 | 50.0 | 8.00 | 7.00 | 6.00 | 4.00 | 2.00 |
| Na-Silicate, R(w) = 3.9 | 40.0 | | 1.00 | 2.00 | 4.00 | 6.00 |
| Sterecoll BL | 30.0 | | | | | |
| Calciumstearaat RG 50/2 | 50.0 | 0.70 | 0.70 | 0.70 | 0.70 | 0.70 |

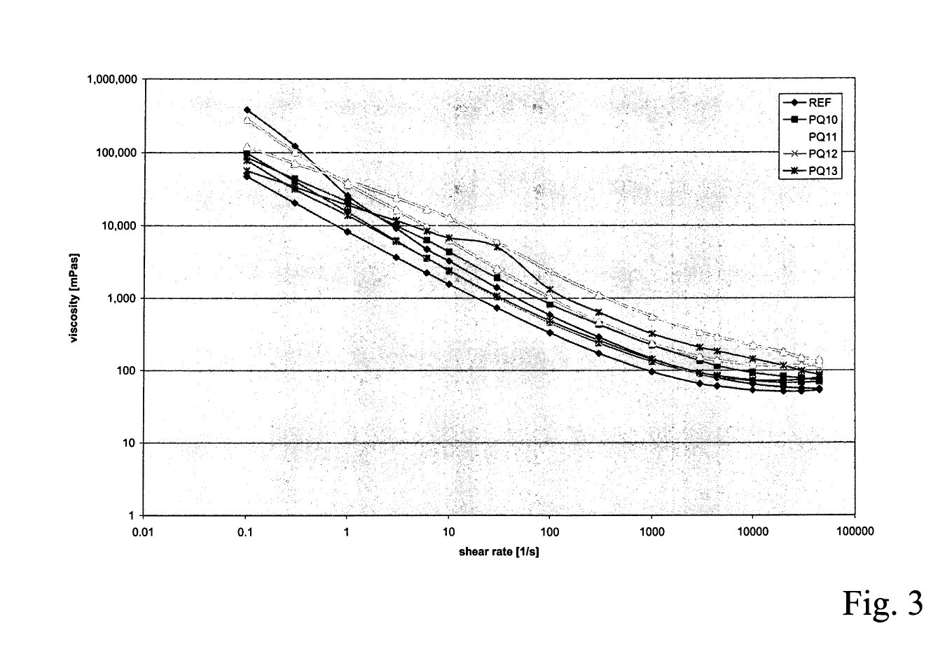

Again after over night storage it was found that viscosity had increased. It was possible to dilute the coating until a better coating viscosity was obtained. Rheological data are given in table 5 and FIG. 3.

TABLE 5
Measurements on wet coatings containing Na-silicate R(w) = 3.9

| Product/Trial-Nr. | | REF | PQ10 | PQ11 | PQ12 | PQ13 |
|---|---|---|---|---|---|---|
| Solid contend | % | 69.3 | 69.2 | 68.8 | 68.2 | 67.8 |
| pH value | | 8.5 | 9.8 | 10.6 | 11.0 | 11.2 |
| Brookfield 100 | mPas | 2550 | 2080 | 1880 | 1420 | 1850 |
| rpm; 23° C. | | | | | | |
| Viscosity | | | | | | |
| Solids after | % | 68.0 | 68.0 | 68.0 | 68.0 | 67.8 |
| preparation | | | | | | |
| Brookfield 100 | mPas | 1990 | 1850 | 2830 | x | x |
| rpm; 23° C. | | | | | | |
| Solids | % | | | | 67.0 | 65.0 |
| Brookfield 100 | mPas | | | | 5800 | 5100 |
| rpm; 23° C. | | | | | | |
| Solids | % | | | | 65.0 | 63.0 |
| Brookfield 100 | mPas | | | | 3150 | 2880 |
| rpm; 23° C. | | | | | | |

As can be seen, dilution to respectively 65% and 63% can be appropriate for coatings with high Na-silicate content (PQ12 and PQ13). It is also seen that pH values remain on a high level. Viscosity curves are measured only with adapted solids after dilution. In FIG. 3 one can see that viscosity for coatings containing Na-silicate is generally higher. Viscosity can be reduced by dilution.

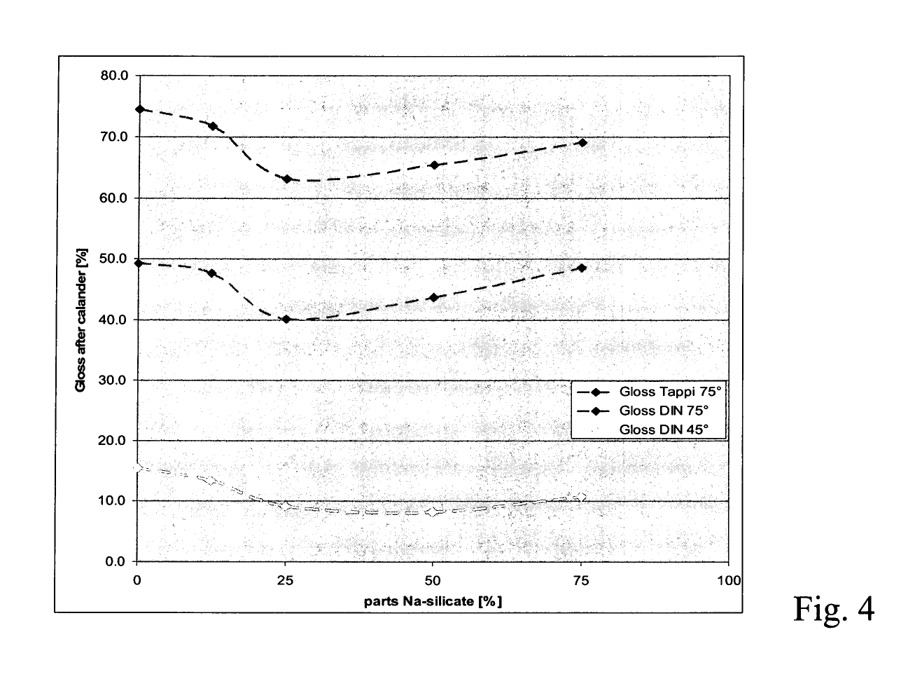

A further focus is on gloss level of the papers before and after calendering. This is given in table 6a) and b). It is remarkable that gloss initially slightly drops after adding some Na-silicate as binder substitute. However, it is also seen that excess Na-silicate results in gloss levels comparable to latex containing reference coating. It is possible to substitute all latex for Na-silicate. FIG. 4 sketches the gloss behaviour as function of % Na-silicate as binder in the formulation.

TABLE 6a
Measurements on coated papers with Na-silicate R(w) = 3.9

| Product/Trial-Nr. | | REF | PQ10 | PQ11 | PQ12 | PQ13 |
|---|---|---|---|---|---|---|
| Spec. Volume | | | | | | |
| Grammage | g/m² | 225.0 | 225.0 | 224.5 | 224.0 | 225.0 |
| Caliper | μm | 237.9 | 236.2 | 235.8 | 236.5 | 237.9 |
| Spec. Volume | cm³/g | 1.06 | 1.05 | 1.05 | 1.06 | 1.06 |
| Coating amount | g/m² | 11.0 | 11.0 | 10.5 | 10.0 | 11.0 |
| Moisture | % | 4.9 | 4.9 | 4.9 | 4.9 | 4.9 |
| Gloss | | | | | | |
| Gloss Tappi 75° | | 37.9 | 36.7 | 29.7 | 29.3 | 35.1 |
| Gloss DIN 75° | | 8.4 | 8.5 | 6.8 | 6.7 | 8.7 |
| Gloss DIN 45° | | 2.4 | 2.3 | 1.7 | 1.4 | 1.6 |
| Roughness | | | | | | |
| PPS roughness | μm | 3.34 | 3.30 | 3.26 | 3.23 | 3.09 |

TABLE 6b
Measurements on calendered papers with Na-silicate R(w) = 3.9

| Product/Trial-Nr. | | REF | PQ10 | PQ11 | PQ12 | PQ13 |
|---|---|---|---|---|---|---|
| Spec. Volume | | | | | | |
| Grammage | g/m² | 225.0 | 225.0 | 224.5 | 224.0 | 225.0 |
| Caliper | μm | 189.6 | 190.3 | 192.8 | 192.5 | 191.6 |
| Spec. Volume | cm³/g | 0.84 | 0.85 | 0.86 | 0.86 | 0.85 |
| Coating amount | g/m² | 11.0 | 11.0 | 10.5 | 10.0 | 11.0 |
| Moisture | % | 4.9 | 4.9 | 4.9 | 4.9 | 4.9 |
| Gloss | | 90° C.; 50 bar; 2 x steel | | | | |
| Gloss Tappi 75° | % | 74.5 | 71.7 | 63.1 | 65.3 | 69.0 |
| Gloss DIN 75° | % | 49.2 | 47.7 | 40.1 | 43.7 | 48.6 |
| Gloss DIN 45° | % | 15.5 | 13.3 | 9.1 | 8.2 | 10.7 |
| Roughness | | | | | | |
| PPS roughness | μm | 0.74 | 0.76 | 0.81 | 0.79 | 0.78 |

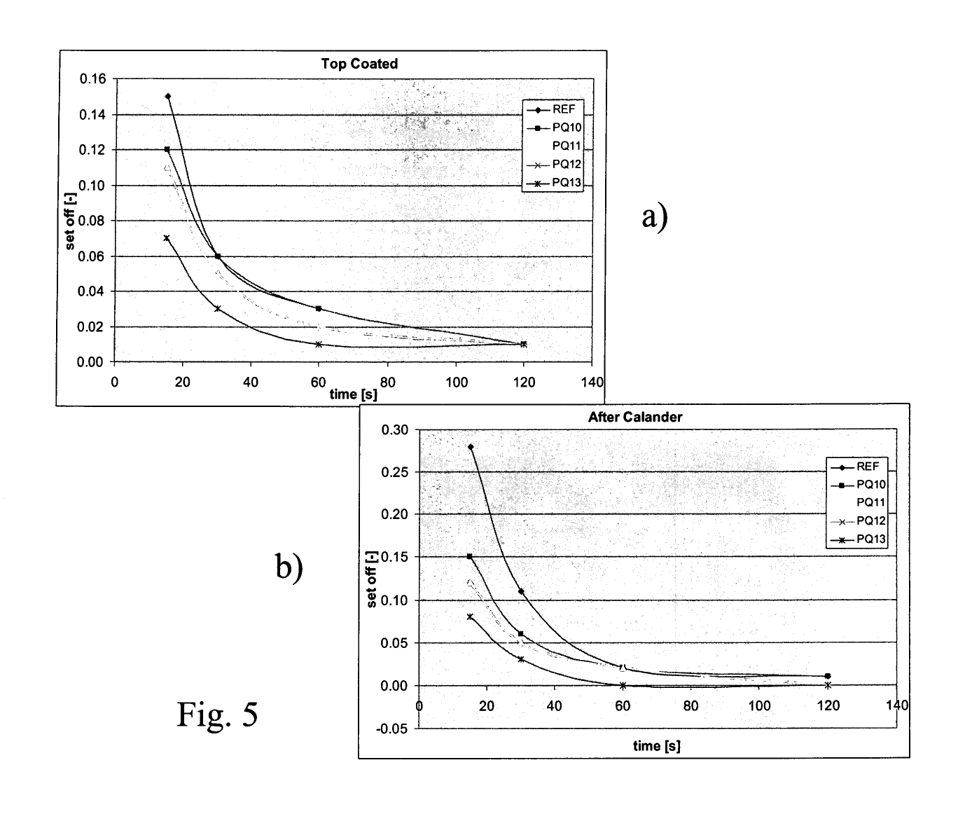

In a further evaluation, printing properties of coated and calendered papers were compared to reference. Set off is given in FIGS. 5a) and b).

A significant and unexpected improvement in ink setting is observed for coated as well as calendered papers. If more latex is substituted by Na-silicate ink setting becomes faster.

Experiments 3: Results with Sodium silicate with R(w)=3.9

In an additional series all latex was substituted for water glass. The following program was set up (see table 7).

TABLE 7
program full substitution of latex with Sodium silicate R(w) = 3.9

| | Trial-Nr. | | |
|---|---|---|---|
| Product | REF | PQ20 | PQ21 |
| Setacarb HG | 97.00 | 97.00 | 97.00 |
| Hydrocarb 60 | 3.00 | 3.00 | 3.00 |
| C*Film 5773 | 0.40 | 0.40 | 0.40 |
| Mowiol 4-98 | 1.80 | 1.80 | 1.80 |
| Eurolatex L 0607 | 8.00 | 5.00 | |
| Na-Silicate, R(w) = 3.9 | | 3.00 | 8.00 |
| Sterecoll BL | | | |
| Calciumstearaat RG 50/2 | 0.70 | 0.70 | 0.70 |
| Blancophor P | 0.30 | 0.30 | 0.30 |
| Solids target A | 68.0 | 67.0 | 63.0 |

As it was learned from previous experiments that coating viscosity can increase as a function of time, the Brookfield viscosity was measured accordingly. It was observed that for all cases viscosity was increasing over time. Further it was also noted that dilution is appropriate in order to bring Brookfield values to proper operating window. In general, it is seen that more water glass needs stronger dilution.

TABLE 8
paper properties of papers up to 100% substitution with water glass

| | | Trial-Nr. | | |
|---|---|---|---|---|
| Product | | REF | PQ20 | PQ21 |
| Spec. Volume | | | | |
| Grammage | g/m² | 222.5 | 222.0 | 225.00 |
| Caliper | μm | 236.9 | 237.2 | 239.40 |
| Spec. Volume | cm³/g | 1.065 | 1.068 | 1.064 |
| Coating amount | g/m² | 10.5 | 10.0 | 13.0 |
| Gloss | | | | |
| Gloss Tappi 75° | | 40.2 | 36.40 | 39.40 |
| Gloss DIN 75° | | 9.3 | 8.90 | 10.40 |
| Gloss DIN 45° | | 2.6 | 1.80 | 2.00 |
| Roughness | | | | |
| PPS roughness | μm | 3.40 | 3.64 | 3.00 |
| Optical properties | | | | |
| ISO Opacity | % | 96.68 | 98.79 | 98.85 |
| D65-Brightness | | 105.01 | 104.97 | 104.41 |
| Basic Brightness | | 88.36 | 88.95 | 89.25 |
| Delta Brightness | | 16.65 | 16.02 | 15.16 |
| CIE-Whiteness | | 138.55 | 136.86 | 134.77 |
| CIE-Lab L* | | 95.69 | 95.94 | 96.02 |
| CIE-Lab a* | | 2.74 | 3 | 2.38 |
| CIE-Lab b* | | −11.05 | −10.55 | −10.04 |
| CIE-Lab L* (−UV) | | 94.68 | 94.96 | 95.08 |
| CIE-Lab a* (−UV) | | −0.05 | −0.03 | −0.06 |
| CIE-Lab b* (−UV) | | −0.72 | −0.7 | −0.72 |

Like in previous experiments, gloss somewhat drops after mixing water glass with latex to certain extent. Going to 100% substitution, however, brings gloss back to its original level (despite significantly lower solids), optical properties remain on an acceptable level.

As can be seen in table 9 below, after calendering this effect is reduced again for Tappi 75° gloss. Note that an advantage is seen in DIN 75° gloss.

TABLE 9
paper properties of calendered papers

| | | Trial-Nr. | | |
|---|---|---|---|---|
| Product | | REF | PQ20 | PQ21 |
| Spec. Volume | | | | |
| Grammage | g/m² | 221 | 222.0 | 225.00 |
| Caliper | μm | 195.5 | 203.7 | 201.00 |
| Spec. Volume | cm³/g | 0.89 | 0.92 | 0.89 |
| Coating amount | g/m² | 9.0 | 10.0 | 13.0 |
| Gloss | | | | |
| Gloss Tappi 75° | % | 73.3 | 63.8 | 67.6 |
| Gloss DIN 75° | % | 41.1 | 34.1 | 43.3 |
| Gloss DIN 45° | % | 12.7 | 6.5 | 9.2 |
| Roughness | | | | |
| PPS roughness | μm | 0.98 | 1.27 | 0.90 |

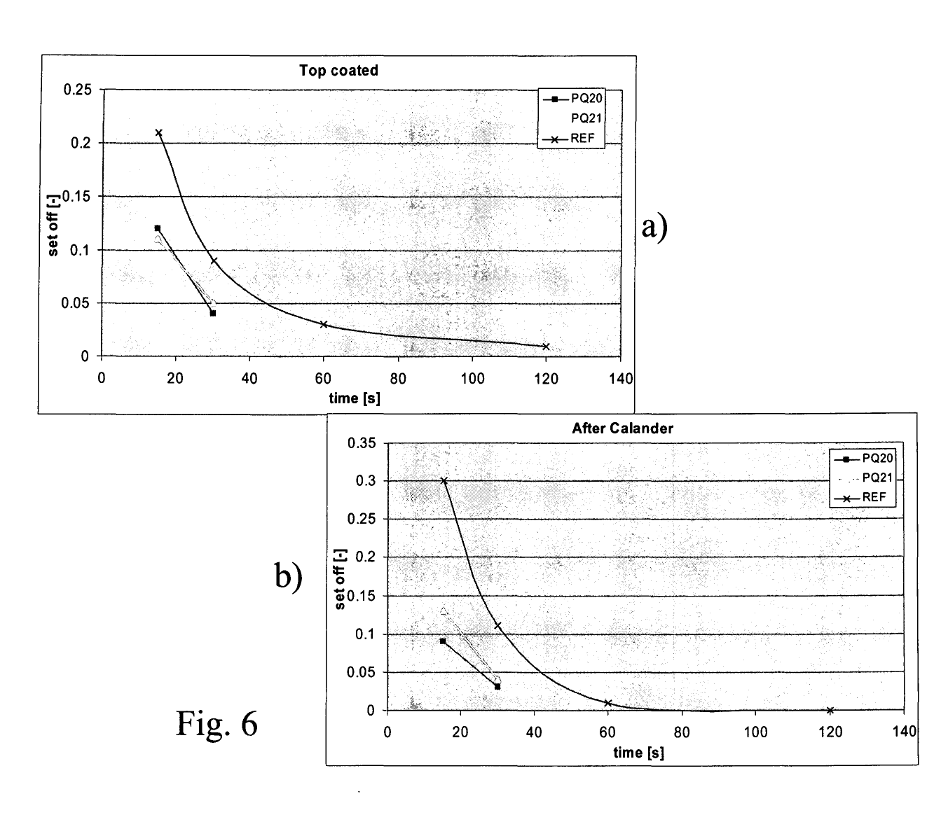

In a further evaluation, printing properties of coated and calendered papers were compared to reference. Set off is given in FIGS. 6a) and b).

It can be seen in the figures that set off is significantly improved for the water glass formulations (coated as well as calendered), resulting in an almost immediately dry paper after 15-30 seconds. It is remarked here that similar effects are also observed with partial substitution of latex for water glass.

Materials and Methods:

Setacarb HG is a fine calcium carbonate pigment with a particle size distribution (psd) such that approximately 90% of the particles are smaller than 1 micrometre. Specifically: 74-76% ds, PSD 87-93%<1 micrometre, 96-100%<2 micrometre, max. 35%<0.2 micrometre, sieve residue 45 micrometre=max 25 ppm, pH=8.5-10.5. Setacarb HG is available from Omya, Switzerland.

Hydrocarb 60 is a fine calcium carbonate pigment with a particle size distribution (psd) such that 60% of all particles are smaller than 2 micrometre. Specifically: 77-79% ds, PSD 57-63%<2 micrometre, 34-40%<1 micrometre, max. 15%<0.2 micrometre, sieve residue 45 micrometre=max 25 ppm, pH=8.5-10.5. Hydrocarb 60 is available from Omya, Switzerland.

C*Film 5773 is an etherified maize starch, supplier Cargill (Cerestar), function: additive/co-binder, Brookfield viscosity of 15% ds at 50° C. and 100 rpm: 230-360 mPa·s, pH=7.0+/−0.5.

Mowiol 4-98 is a PVA type additive, supplier Kuraray, acts as additive/co-binder, indicated as ‘fully’ hydrolysed from polyvinyl acetate, hydrolysis degree 98.4+/−0.4 mol %, viscosity of a 4% ds aqueous solution at 20° C.=4.5+/−0.5, average M_{w}=27000 (g/mol).

Eurolatex L 0607 is a latex binder, specifically a carboxylated styrene butadiene latex binder, supplier EOC (Oudenaarde, BE), 50.0+/−1.0% ds, pH=6.45=/−0.25, Brookfield 100 rpm and 20° C.: 120+/−50 mPa·s, sieve residue 45 micrometre=max. 60 ppm, Minimal Film Formation Temperature<5° C.

Sterocoll is a synthetic thickener (rheology modifier) based on an anionic emulsion of copolymer of acrylic acid and acrylic amide, supplier BASF, 31.0-35.0% ds, Brookfield viscosity 30 rpm and 20° C.=300-1200 mPa·s.

Calciumstearat RG 50/2: supplier EKA-Nobel, 50.0+/−1.0% ds, sieve residue 45 micrometre=max. 300 ppm, Brookfield viscosity 100 rpm, 20° C.=100-150 mPa·s, pH=9.0-10.5.

Since sodium silicates are produced from two abundant materials on earth in a relatively simple process, its cost price is also in correspondence. Typical prices for standard materials are significantly lower than for latex.

Final Conclusions: Application of the coatings onto paper is readily possible in desired coat weights. Printing of these papers e.g. showed a substantial improvement in set off, after coating as well as after calendering. It is recognized that the first 2 parts show largest improvement increase. Complete substitution results in zero set off after approximately 40 seconds for coated as well as calendered papers.

1. Printing sheet for offset printing, comprising at least one image receiving coating and optionally one or several pre-coatings beneath said image receiving coating, said coatings comprising a pigment part, a binder part, and optionally additives, wherein the pigment part essentially comprises one or a mixture of fine particulate pigments selected from the group of carbonate, kaolin, gypsum, clay, silica, solid or vacuolated polymer pigment, wherein said binder part comprises waterglass.

2. Printing sheet according to claim 1, wherein at least one of the pre-coatings beneath said image receiving coating has a binder part comprising waterglass, and wherein the image receiving coating has a binder part free from waterglass.

3. Printing sheet according to claim 1, wherein the image receiving coating and/or at least one of the pre-coatings comprises a pigment part, a binder part, and optionally additives, wherein the pigment part essentially comprises one or a mixture of fine particulate pigments selected from the group of carbonate, kaolin, gypsum, clay, silica, solid or vacuolated polymer pigment, and wherein said binder part in the image receiving coating and/or of the pre-coating(s) comprises waterglass.

4. Printing sheet according to claim 1, wherein for a pigment part of 100 parts per dry weight the binder is present as 2-18 parts per dry weight, preferably 3-12 parts per dry weight, even more preferably 6-10 parts per dry weight, optional additives constituting another 0-5 parts per dry weight, preferably 0.1-2 parts per dry weight.

5. Printing sheet according to claim 1, wherein at least 10% of the dry weight of the binder part and preferably not more than 90% is constituted by waterglass.

6. Printing sheet according claim 1, wherein 45%-80%, preferably 50%-70% of the dry weight of the binder part is constituted by waterglass.

7. Printing sheet according to claim 1, wherein, essentially all of the binder part is constituted by waterglass.

8. Printing sheet according to claim 5, wherein the remainder of the binder part is constituted by another binder, preferably selected from the group consisting of latex, in particular styrene-butadiene, styrene-butadiene-acrylonitrile, carboxylated styrene-butadiene, styrene-acrylic, styrene-butadiene-acrylic latexes, starch, polyacrylate salt, polyvinyl alcohol, soy, casein, carboxymethyl cellulose, starch, hydroxymethyl cellulose and mixtures thereof.

9. Printing sheet according to claim 1, wherein at least 50%, preferably at least 75% of the dry weight of the pigment part consists of a carbonate and/or kaolin pigment.

10. Printing sheet according to claim 1, wherein the pigment part is composed of a) 50 to 100 parts in dry weight of a particulate carbonate with a particle size distribution such that more than 60% preferably more than 80% of the particles are smaller than 2 preferably than 1 μm, preferably with a particle size distribution such that approximately 90% of the particles are smaller than 2 preferably than 1 μm, b) 0 to 50 parts in dry weight of a fine particulate kaolin with a particle size distribution such that more than 90% of the particles are smaller than 1 μm, preferably with a particle size distribution that more than 95% of the particles are smaller than 1 μm, c) 0 to 20 parts or up to 30 parts in dry weight of a particulate, preferably solid or vacuolated polymer pigment with in case of a solid polymer pigment a particle size distribution such that more than 90% of the particles are smaller than 0.5 μm, preferably with a particle size distribution such that 90% of the particles have sizes between 0.05 and 0.3 μm, in particular between 0.1 and 0.2 μm, and in case of vacuolated polymer pigment with a mean particle size in the range 0.6-1 μm, d) 0-20 parts in dry weight, preferably 0.5-10 parts in dry weight of another pigment, preferably of a particulate carbonate and/or kaoline with a particle size distribution such that more than 50% of the particles are smaller than 2 μm, preferably with a particle size distribution such that approximately 60% of the particles are smaller than 2 μm, the total of the pigment part making 100 parts in dry weight.

11. Printing sheet according to claim 10, wherein the pigment part is composed of 85 to 98 parts in dry weight of a particulate carbonate with a particle size distribution such that more than 80% of the particles are smaller than 1 μm, preferably with a particle size distribution such that approximately 90% of the particles are smaller than 1 μm, and of 2-15 parts in dry weight, preferably 0.5-10 parts in dry weight of a particulate carbonate with a particle size distribution such that more than 50% of the particles are smaller than 2 μm, preferably with a particle size distribution such that approximately 60% of the particles are smaller than 2 μm.

12. Printing sheet according to claim 10, wherein the pigment part is composed of up to 100% in dry weight of a particulate carbonate with a particle size distribution such that more than 60% of the particles are smaller than 2 μm.

13. Printing sheet according to claim 1, that the additives are selected from the group of defoamers, colorants, brighteners, dispersants, thickeners, water retention agents, preservatives, crosslinkers, lubricants and pH control agents and mixtures thereof.

14. Printing sheet according to claim 1, wherein the image receiving layer has a total dried coat weight of in the range of 3 to 25 g/m², preferably in the range of 4 to 15 g/m², and most preferably of about 6 to 12 g/m².

15. Printing sheet according to claim 1, characterised by a gloss on the calendered surface of the image receptive coating of more than 70% according to TAPPI 75 deg.

16. Printing sheet according to claim 1, wherein the weight ratio of SiO₂:Na₂O in the waterglass is above or equal to 3.2, preferably above or equal to 3.4, most preferably above or equal to 3.6, or above or equal to 3.8.

17. Printing sheet according to claim 1, wherein the waterglass is supplemented with additives and/or is chemically modified.

18. Printing sheet according to claim 1, wherein the binder part of at least one of the coating layers, preferably of the middle coating layer, and most preferably only of the middle coating layer, comprises, preferably consists of, a conventional binder of the latex type, waterglass as well as a starch type binder.

19. Printing sheet according to claim 18, wherein the starch part of the binder part makes 5-30%, preferably 10-15% of the total weight of the binder part, wherein the waterglass part makes 0.5-50%, preferably 15-30% of the total weight of the binder part, and wherein the remainder of the total weight of the binder part complementing to 100% is given by the latex type binder.

20. Printing sheet according to claim 18, wherein the starch type binder is selected from the group of hydroxy propylated starch or dextrine starch or combinations thereof

21. Printing sheet according to claim 1, wherein the binder part comprises a further binder apart from waterglass, preferably a latex binder, wherein this further binder is selected such that the Brookfield viscosity at 100 rpm at a temperature of 23° C. and at solids content of in the range of 65-70% of the coating formulation remains below 2000 mPa·s after six hours, preferably relating below 1800 mPa·s after six hours.

22. Printing sheet according to claim 1, wherein the waterglass content in the binder part is below 3 parts per weight, preferably below or equal to 2 parts per weight.

23. Printing sheet according to claim 1, wherein the additives comprise components acting as co-binders in an amount of 0.1-1.5 parts per dry weight, preferably 0.5-1.0 parts per dry weight, wherein preferably the specific additives are selected from the group starch, in particular etherified starch, preferably etherified maize starch, PVA, CMC.

24. Printing sheet according to claim 1, wherein the turbidity of the waterglass solutions used in the coating process is in the range of 1-4 NTU preferably in the range of 2-3 NTU.

25. Printing sheet according to claim 1, wherein it comprises a rheology modifier which is active at a pH-value of about 9-11.5.

26. Method for making a printing sheet according to claim 1, wherein during coating preparation and/or application the pH value of the coating formulations comprising waterglass is kept in the range of 10.5-11.5 or smaller or equal to 10.

27. Method according to claim 25, wherein if at least 50% of the binder part is constituted by waterglass dilution of the coating formulation to below 70%, preferably to at most 65% can be carried out prior to application of the coating.

28. Method according to claim 25, wherein if at least 75% of the binder part is constituted by waterglass dilution of the coating formulation to at most 65% can be carried out prior to application of the coating.

29. Method according to claim 24, wherein for the making of the coating formulation a waterglass solution is used the turbidity of which is in the range of 1-4 NTU preferably in the range of 2-3 NTU.

30. Method according to claim 24, wherein for the making of the coating formulation a rheology modifier is used which is active as rheology modifier at a pH-value of about 9-11.5.

31. Use of a printing sheet according to claim 1 in an offset printing process.
